(19) United States
(12) Patent Application Publication
(10) Pub. No.: US 2008/0071856 A1
(43) Pub. Date: Mar. 20, 2008

(54) Network system, network device, and program product

(75) Inventors: Tatuya Katoh, Nagoya-city (JP); Jiro Sato, Obu-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/898,250

(22) Filed: Sep. 11, 2007

(30) Foreign Application Priority Data
Sep. 19, 2006 (JP) 2006-252923

(51) Int. Cl. G06F 15/16

(52) U.S. Cl. 709/202

(57) ABSTRACT

In a remote control system, a remote ECU as a primary device can transmit, to a secondary device, an instruction message for ordering an execution of a process in a state where a response method according to the content of the process can be specified. The secondary device which receives the instruction message can transmit a response message to the primary device according to the response method specified in the instruction message while executing the corresponding process. That is, the secondary device can transmit the response message in the pattern according to the convenience of the primary device. The response message can be designed to indicate the response method not to transmit a response message unnecessary for the primary device to prevent an unnecessary response message from being transmitted. Communication loads can be decreased on the network; the response of the secondary device can be enhanced to the instruction from the primary device.

### CROSS REFERENCE TO RELATED APPLICATION

This application is based on and incorporates herein by reference Japanese Patent Application No. 2006-252923 filed on Sep. 19, 2006.

### FIELD OF THE INVENTION

The present invention relates to a network system which includes multiple network devices communicated with each other.

### BACKGROUND OF THE INVENTION

There is known a network system in which a network device as a primary device (so called “master”) controls other network devices as secondary devices (so called “slaves”) (Refer to Patent document 1).
Patent document 1: JP-2000-250850 A

In such a system, after receiving an instruction from the primary device, the secondary device transmits a response to the primary device in a predetermined pattern. After receiving the response, the primary device continues subsequent processes.

Thus, the response to the primary device is conventionally performed from the secondary device in only the predetermined pattern. The secondary device may transmit a response unnecessary for the primary device. This increases communication loads on the network or worsens the response from the secondary device to the instruction of the primary device.

### SUMMARY OF THE INVENTION

The present invention is made to solve such a problem. It is an object to provide a technology for reducing communication loads on a network and enhancing a response from a secondary device to an instruction message of a primary device.

To achieve the above object, as an example of the present invention, a network system is provided as follows. The network system includes a plurality of network devices communicably connected with each other. A primary device as one of the network devices controls a secondary device as one of the other network devices. The primary device comprises an execution instruction unit and an information addition unit. The execution instruction unit is configured to transmit an instruction message for ordering an execution of a predetermined process to the secondary device when a predetermined instruction condition is fulfilled. The information addition unit is configured to add, to the instruction message, method information indicating a response method according to the instruction condition. The secondary device comprises a process execution unit and an instruction response unit. The process execution unit is configured to execute a predetermined process according to the instruction message when the instruction message is received from the primary device. The instruction response unit is configured to generate a response message according to the response method indicated by the method information, and transmit the generated a response message to the primary device.

As another example of the present invention, a network device comprises all the units included in the primary device in the above network system.

As another example of the present invention, a network device comprises all the units included in the secondary device in the above network system.

As another example of the present invention, a computer program product in a computer-readable medium comprises instructions for achieving all the units included in the primary device of the above network system.

As another example of the present invention, a computer program product in a computer-readable medium comprises instructions for achieving all the units included in the secondary device of the above network system.

As yet another example of the present invention, a method is provided for indicating a response method in a network system communicably connecting a primary device and a secondary device controllable by the primary device. The method comprises the steps of: transmitting an instruction message from the primary device to the secondary device when a predetermined instruction condition is fulfilled, the instruction message ordering an execution of a predetermined process and further indicating a response method according to the instruction condition; receiving the instruction message in the secondary device; executing the predetermined process ordered by the received instruction message in the secondary device; and generating a response message according to the response method indicated by the received instruction message to thereby transmit the generated response message from the secondary device to the primary device.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram showing a configuration of a network system according to an embodiment of the present invention;

FIG. 2 is a flowchart diagram illustrating a remote process;

FIG. 3 is a flowchart diagram illustrating an execution request process;

FIG. 4 is a diagram illustrating a data structure of an instruction message;

FIG. 5 is a flowchart diagram illustrating an execution response process; and

FIG. 6 is a time chart diagram illustrating procedures of a primary device and a secondary device.

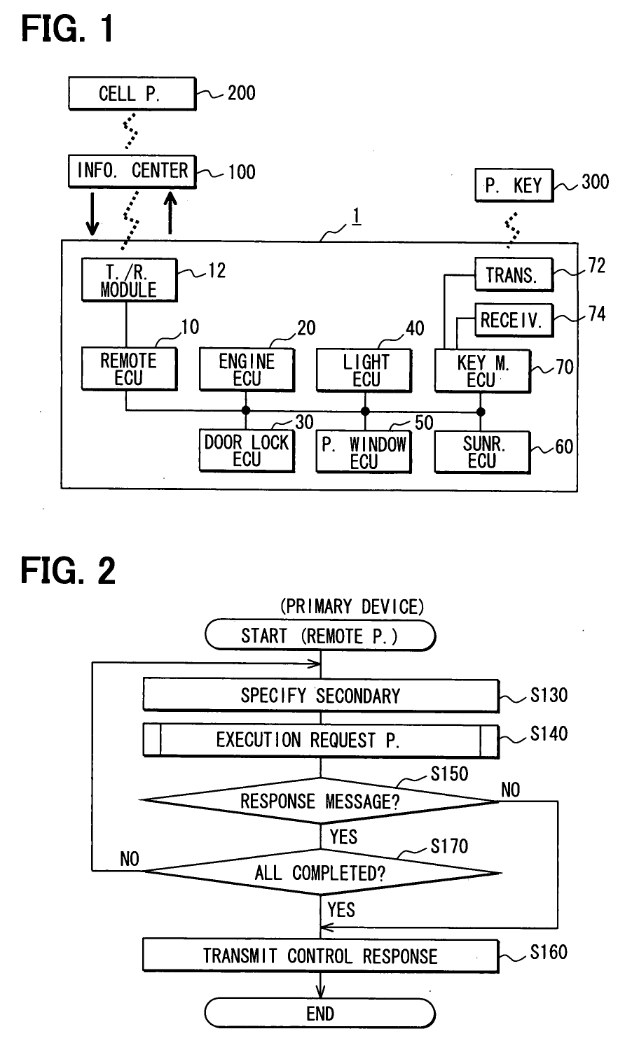

### DETAILED DESCRIPTION OF THE PREFERRED EMBODIMENTS

An embodiment of the present invention is directed to a network system as a vehicle remote control system mounted in a subject vehicle.

(1) Configuration

A vehicle remote control system 1 includes multiple network devices communicably connected with each other via a network (i.e., CAN (Controller Area Network)). One of the network devices serves as a primary device. The primary device controls the other network devices as secondary devices.

In this embodiment, multiple electronic control units (ECU) which control operations of various parts of the vehicle are connected to the network as the network devices. Among the multiple ECUs, a remote ECU 10 serves as the primary device to control other ECUs.

The ECUs connected to the network include a remote ECU 10 to control each ECU, an engine ECU 20 to control the engine of the vehicle, a door lock ECU 30 to control lock of doors of the vehicle, a light ECU 40 to control lights of the vehicle, a power window ECU 50 to control opening and closing of windows of the vehicle, a sunroof ECU 60 to control opening and closing of a sunroof of the vehicle, and a key matching ECU 70 to collate a key for starting the vehicle.

The remote ECU 10 receives a control instruction which indicates a control content of each part of the vehicle from an information center 100 through a data transmission and reception module 12. The remote ECU 10 controls each ECU by executing a process based on the received control instruction.

The information center 100 is connectable through the network, such as the Internet, from a portable terminal (e.g., cell phone) 200. The information center 100 receives a control instruction from the connected portable terminal 200 and relays it to the vehicle remote control system 1. Here, the control instruction can specify control contents such as (i) which part of the vehicle should be controlled, (ii) an order in controlling multiple parts, and (iii) what kind of process a secondary device is made to perform.

The key matching ECU 70 exchanges information for collating with a portable key 300 through a transmitter 72 and a receiver 74, and collates the portable key 300 based on the information.

(2) Remote Process by the Primary Device

The remote ECU 10 as the primary device performs a procedure of a remote process according to the program stored in the internal memory. The procedure of the remote process will be explained with reference to FIG. 2. The remote process is started when the control instruction is received through the data transmission and reception module 12.

After start of the remote process, the remote ECU 10 specifies a secondary device, which is required to perform an execution of a process, and a content of the process (S130). When S130 is performed for the first time after the start of the remote process, an ECU corresponding to a secondary device which should be controlled first is specified according to the control content specified by the control instruction received before the start of the remote process. In contrast, when S130 is performed for the second time or later after the start of the remote process, an ECU corresponding to a secondary device which should be controlled second or later is specified based on the received control instruction. Then, the content of the process, which the corresponding ECU should be required to perform, is specified based on the control instruction.

Next, on condition that the secondary device and the content of the process are specified at S130, an execution request process is performed with both the secondary device and the content of the process being regarded as an argument (S140).

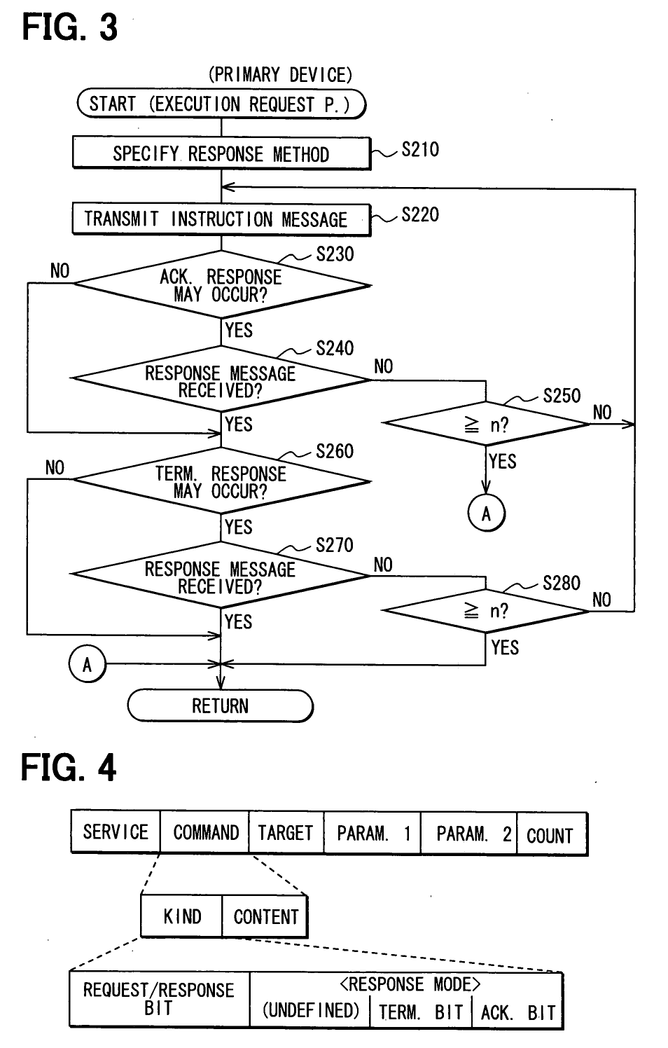

In the execution request process, as indicated in FIG. 3, a response method, by which the secondary device responds to the primary device, is specified based on the content of the process specified at S130 (S210). Here, based on the content of the process specified at S130, any one of the following four response methods is specified: (i) responding none (i.e., not responding anything) to an instruction message (none response); (ii) responding that the instruction message is received (acknowledgment response); (iii) responding that the process is executed according to the instruction message (termination response); and (iv) responding the preceding two (acknowledgment and termination response).

Then, an instruction message as instruction information for requiring an execution of the content of the process specified at S130 is transmitted to the secondary device specified at S130 in the state where a parameter indicating the response method specified at S210 is set up (S220).

In the embodiment, as indicated in FIG. 4, data of a message format having six bytes is used as the instruction message, and transmitted to the secondary device after each parameter is set in a corresponding field within the data.

In detail, a parameter which specifically indicates the content of the process specified at S130 is set in a field (service kind, demand command) about the content of the process. A parameter which indicates the secondary device specified at S130 is set in a field (service kind, instruction target) about a transmission destination of the instruction message. A value which indicates the response method specified at S210 is set in a field (demand command) about the response method.

The value which indicates the response method specified at S210 is as follows: “01” in which “1” is set only to the acknowledgment response bit of the command kind in the demand command field for the acknowledgment response; “10” in which “1” is set only to the termination response bit of the command kind for the termination response; “11” in which “1” is set to both the bits of the acknowledgment response and the termination response of the command kind for the acknowledgment and termination response; and “00” in which “0” is set to both bits for the none response.

Then, it is determined after transmission of the instruction message at S220 whether a response indicating that the instruction message is received may occur (S230). Here, when the acknowledgment response or the acknowledgment and termination response is specified as the response method at S210, it is determined that the response (acknowledgment response) indicating that the instruction message is received may occur.

When it is determined that the response indicating that the instruction message is received may occur (S230: YES), S240 is performed. When a response message as response information is not received from the secondary device for a predetermined time after the instruction message is transmitted (S240: NO), S250 is performed. Until a count of transmissions of the instruction message reaches a predetermined value (n) (S250: NO), the process returns to S220 to repeat the transmission of the same instruction message (S220 to S250).

When it is determined that the response indicating that the instruction message is received may occur (S230:YES) and the response message is received from the secondary device for the predetermined time after the instruction message is transmitted (S240: YES), S260 is performed. Further, when it is not determined that the response indicating that the instruction message is received may occur (S230: NO), S260 is also performed. At S260, it is determined whether a response (termination response) indicating that a process is executed according to the instruction message may occur. Here, when the termination response or the acknowledgment and termination response is specified as the response method at S210, it is determined that the response indicating that a process is executed based on the instruction message may occur.

When it is determined that the response indicating that a process is executed based on the instruction message may occur (S260: YES), S270 is performed. When the response message is not received from the secondary device for a predetermined time after the instruction message is transmitted (S270: NO), S280 is performed. Until a count of transmissions of the instruction message reaches a predetermined value (n) (S280: NO), the process returns to S220 to repeat the transmission of the same instruction message (S220 to S280).

When it is determined that the response may occur (S260: YES) and the response message is received from the secondary device for the predetermined time after the instruction message is transmitted (S270: YES), or when it is not determined that the response may occur (S260: NO), the process returns to the remote process with the response message received at S240 and S270 regarded as return values.

In contrast, when it is determined that the count of transmissions of the instruction message reaches the predetermined value (n) (S250: YES, S280: YES), the process returns to the remote process with an error of no reception of the response message regarded as a return value.

Thus, after the execution request process at S140 is performed, it is determined whether the return value in the execution request process is “response message” (S150).

When it is determined that the return value is “error” (S150: NO), the control response which indicates that the control result based on the control instruction is “error” is transmitted to the information center 100 through the data transmission and reception module 12 (S160). The remote process is then completed.

In contrast, when it is determined that the return value is “response message” (S150: YES), It is determined whether all the controls according to the control instruction received before the start of the remote process are completed (S170).

When it is determined that all the controls are not completed (S170: NO), the process returns to S130, where a secondary device, which is required to perform an execution of a process, and a content of the process are specified. Here, as explained above, according to the control instruction, an ECU corresponding to a part which should be controlled next is specified as a corresponding secondary device.

Thus, S130 to S150, and S170 are repeated until all the controls according to the control instruction are completed. When it is determined that all the controls are completed (S170: YES), the process shifts to S160. At S160, the control response indicating “response message” as the return value at S140 (execution request process) is transmitted to the information center 100 through the data transmission and reception module 12. Then, the remote process is completed.

(3) Execution Response Process by the Secondary Device

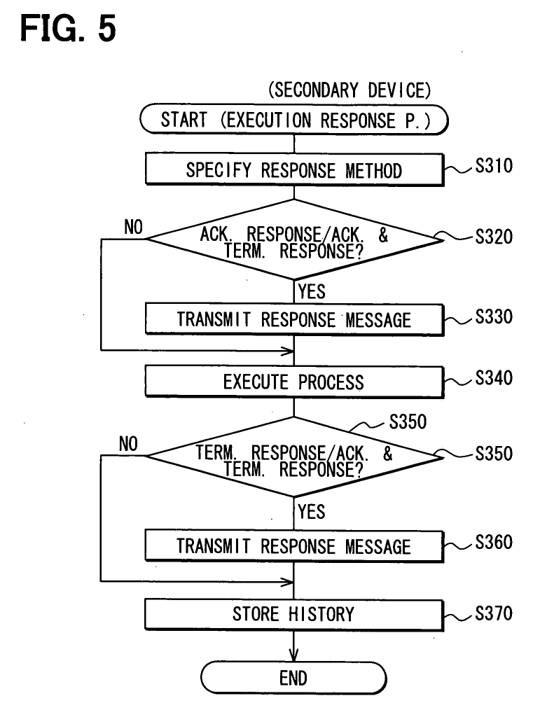

Each ECU 20 to 70 as the secondary device performs a procedure of an execution response process according to a program stored in the internal memory. The procedure of the execution response process will be explained with reference to FIG. 5. The execution response process is started each time the secondary device receives an instruction message from the primary device through the network. In addition, when another instruction message is received from the primary device during operation of a first execution response process, a new second execution response process is started in parallel with the first execution response process under operation. In addition, the instruction message is transmitted from the primary device at S220 in FIG. 3.

When the execution response process is started, the response method is first specified based on the field about the response method included in the instruction message received before the start (S310).

When the response method specified at S310 is the acknowledgment response or the acknowledgment and termination response (S320: YES), a response message as response information indicating that the instruction message is received is generated and transmitted to the primary device (S330). In addition, the instruction message transmitted is received by the primary device at S240 in FIG. 3.

When S330 is completed or when the response method specified at S310 is not the acknowledgment response or the acknowledgment and termination response (S320: NO), S340 is performed. Here, the process corresponding to the content of the process indicated by the instruction message is performed (S340).

When the response method specified at S310 is the termination response or the acknowledgment and termination response (S350: YES), a response message indicating a result of the execution at S340 is generated and transmitted to the primary device (S360). This response message indicates the state of the secondary device after the execution of the process, and is received by the primary device at S270 in FIG. 3.

When S360 is completed or when the response method specified at S310 is not the termination response or acknowledgment and termination response (S350: NO), a process history based on the execution result at S340 is stored in the internal memory (S370). The execution response process is then completed.

At S370, the following information is stored in the internal memory as a process history or overwritten when already stored: the content (process content) of the process executed at S340; the state of the secondary device after the execution of the process; the response method; and the information groups such as an execution clock time.

(4) Effects

According to the vehicle remote control system 1, the remote ECU 10 as the primary device can transmit an instruction message for ordering an execution of a process to a secondary device, in the state where the response method according to the content of the process can be specified (S210, S220 in FIG. 3). The secondary device which receives the transmitted instruction message can transmit the response message to the primary device in accordance with the response method specified in the instruction message (S320 to S360 in FIG. 5) while executing the corresponding process (S340 in FIG. 5).

In other words, according to the system, the secondary device can transmit the response message in the pattern according to the convenience of the primary device without restricted to the predetermined pattern. The response message can be designed to indicate the response method not to transmit a response message unnecessary for the primary device. Thus an unnecessary response message can be prevented from being transmitted. Thereby, communication loads can be decreased on the network; the response of the secondary device can be enhanced to the instruction from the primary device.

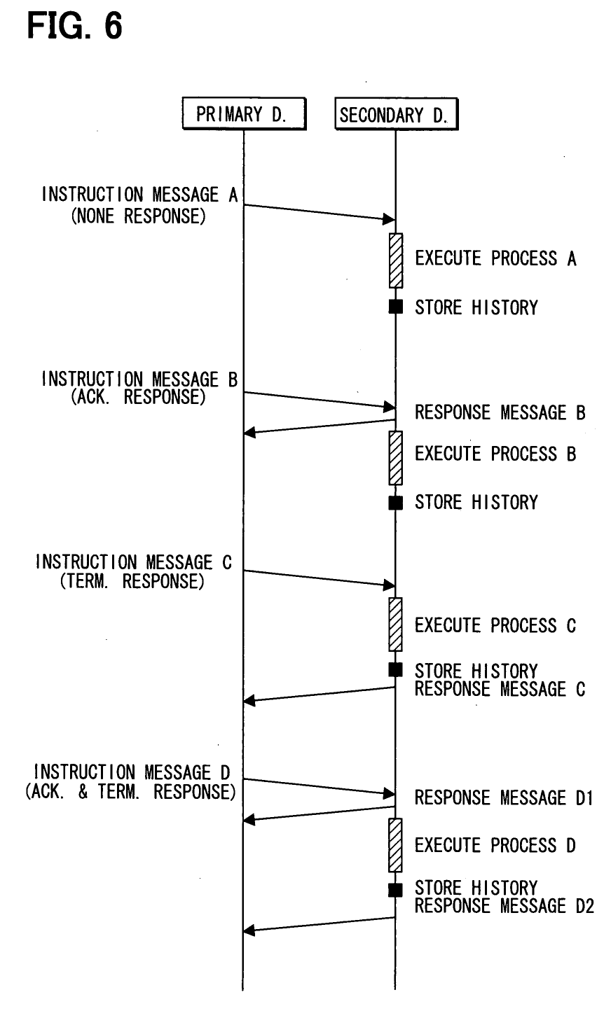

For instance, the primary device can transmit the instruction message according to the content of the process specified at S130 in FIG. 2 in the state where the response method of answering that the instruction message is received can be specified (refer to “instruction message B” and “instruction message D” in FIG. 6). The secondary device which receives the instruction message can transmit to the primary device the response message indicating that the instruction message is received while executing the corresponding process (refer to “response message B” and “response message D1” in FIG. 6).

Further, the primary device can transmit the instruction message according to the content of the process specified at S130 in FIG. 2 in the state where the response method of answering that the process according to the instruction message is executed can be specified (refer to “instruction message C” and “instruction message D” in FIG. 6). The secondary device which receives the instruction message can transmit to the primary device the response message indicating that the process is executed according to the instruction message while executing the corresponding process (refer to “response message C” and “response message D2” in FIG. 6).

Thus, a response message can be transmitted in a pattern according to the convenience of the primary device. For example, the response from the secondary device may not be needed in continuing the subsequent process after transmitting the instruction message to the secondary device. In such a case, an instruction message may be transmitted to the secondary device in the state where the response method indicating no need of any response can be specified.

In this case, it is not necessary to wait for the response from the secondary device in continuing the subsequent process after transmitting an instruction message. This helps prevent the situation where the subsequent process is uncontinuable since the response does not arrive, e.g., because of the trouble in the communication channel between the primary device and the secondary device.

(5) Modifications

Although the embodiment of present invention is explained above, the present invention is not limited to the above embodiment at all and can be adapted to various embodiments as long as within a technical scope of the present invention.

For instance, in the above embodiment, the network system of the present invention is provided to the vehicle remote control system having multiple ECUs which control operations of various parts of the vehicle. However, the network system may be applied to any other system in which multiple network devices are communicably connected with each other.

Moreover, in the above embodiment, on condition that the secondary device and the content of the process are specified at S130, an execution request process is executed (S140). However, the condition used as the trigger, by which this execution request process is executed, may be that the primary device specifies the process which the secondary device should execute or that the time point when the process should be executed is reached in a different process other than the remote process in FIG. 2.

Moreover, in the above embodiment, in the execution request process, an instruction message is repeatedly transmitted until the response message from the secondary device is received within the predetermined time after transmission of the instruction message (S250, S280 to S220 in FIG. 3). However, after transmission of the instruction message, the process may stand by until a response message is received. In this case, S240 and S270 may be modified to stand by until it receives a response message.

Moreover, in the above embodiment, the response methods based on the instruction message include four kinds such as none response, acknowledgment response, termination response, and acknowledgment and termination response. However, another response method may be adopted, e.g., intermediate response that a response is made in the middle of the process, and interval response that a response is made after a predetermined time elapses from the start or the completion of the process.

Each or any combination of processes, steps, or unit explained in the above can be achieved as a software unit (e.g., subroutine) and/or a hardware unit (e.g., circuit or integrated circuit), including or not including a function of a related device; furthermore, the hardware unit can be constructed inside of a microcomputer.

Furthermore, the software unit or any combinations of multiple software units can be included in a software program, which can be contained in a computer-readable storage media or can be downloaded and installed in a computer via a communications network.

(6) Functions

In the embodiment described above, S130 in FIG. 2, where the secondary device and the content of the process are specified may function as an instruction condition.

Moreover, S220 in FIG. 3 may function as an execution instruction unit or unit or an information addition unit or unit; S340 in FIG. 5 may function as a process execution unit or unit; and S330, S360 in FIG. 5 may function as an instruction response unit or unit.

(7) Aspects of Subject Matter

Aspects of the subject matter described herein are set out in the following clauses.

As a first aspect, a network system is provided as follows. Multiple network devices are included to be communicable with each other. A primary device among the network devices controls other network devices as secondary devices.

The primary device in the network system includes: an execution instruction unit for transmitting an instruction message for ordering an execution of a predetermined process to the secondary device when a predetermined instruction condition is fulfilled; and an information addition unit for adding method information which indicates a response method to responding to the instruction message transmitted by the execution instruction unit.

Moreover, the secondary device includes: a process execution unit for performing a predetermined process according to an instruction message received from the primary device; and an instruction response unit for transmitting a response message to respond based on the instruction message after receiving the instruction message from the primary device, in accordance with a response method indicated in the method information added to the instruction message.

According to the network system, the primary device can transmit the instruction message for ordering an execution of a process to be accompanied by the method information indicating a response method according to an instruction condition which has triggered transmission of the instruction message. The secondary device which received the instruction message can transmit the response message to the primary device in accordance with the response method indicated in the method information added to the instruction message while performing the process according to the received instruction message.

In other words, according to the system, the secondary device can transmit the response message in the pattern according to the convenience of the primary device without restricted to the predetermined pattern. The response message can be designed to indicate the response method not to transmit a response message unnecessary for the primary device. Thus an unnecessary response message can be prevented from being transmitted. Thereby, communication loads can be decreased on the network; the response of the secondary device can be enhanced to the instruction from the primary device.

Further, in the primary device, the “instruction condition” serves as a trigger for the execution instruction unit to transmit the instruction message to the secondary device. The instruction condition may be fulfilled when a process for the secondary device to execute is specified based on an instruction externally received by the primary device, or at the time point when the execution of the process should be started.

Moreover, the “response method according to the instruction condition” is indicated in the method information which the information addition unit adds to the instruction message. For example, the response method includes what kind of pattern the response should be made to the primary device in the process which should be performed when the instruction condition is fulfilled.

For instance, a response method is to respond that the instruction message is received. As a second aspect, to achieve such a response method, the above network system may be configured as follows.

In the primary device of the network system, the information addition unit adds, to the instruction message, method information indicating a response method to respond that the instruction message is received. In the secondary device, when the response method is to respond that the instruction message is received, the instruction response unit generates a response message for responding that the instruction message is received, and transmits the generated response message to the primary device.

Thus, the primary device can transmit the instruction message, which is accompanied by the response message indicating the response method of responding that the instruction message is received. The secondary device which receives the instruction message can transmit to the primary device the response message indicating that the instruction message is received while executing the corresponding process.

In addition, the process execution unit in this configuration may be provided as executing the process at a time when the instruction message is received from the primary device, or as executing the process at a time after transmitting the response message to the primary device.

For instance, a response method is to respond that the process is executed according to the instruction message. As a third aspect, to achieve such a response method, the network system of the first aspect may be configured as follows.

In the primary device of the network system, the information addition unit adds, to the instruction message, method information indicating a response method to respond that the process is executed according to the instruction message. In the secondary device, when the response method is to respond that the process is executed according to the instruction message, the instruction response unit generates a response message for responding that the process is executed according to the instruction message, and transmits the generated response message to the primary device.

Thus, the primary device can transmit the instruction message, which is accompanied by the response message indicating the response method of responding that the process is executed according to the instruction message. The secondary device which receives the instruction message can transmit to the primary device the response message indicating that the process is executed according to the instruction message while executing the corresponding process.

As a fourth aspect, a network device comprises all the units included in the primary device in the network system of the first aspect.

As a fifth aspect, a network device comprises all the units included in the secondary device in the network system of the first aspect.

As a sixth aspect, a computer program product in a computer-readable medium comprises instructions for achieving all the units included in the primary device of the above network system of the first aspect.

As a seventh aspect, a computer program product in a computer-readable medium comprises instructions for achieving all the units included in the secondary device of the above network system of the first aspect.

As an eighth aspect, a method is provided for indicating a response method in a network system communicably connecting a primary device and a secondary device controllable by the primary device. The method comprises the steps of: transmitting an instruction message from the primary device to the secondary device when a predetermined instruction condition is fulfilled, the instruction message ordering an execution of a predetermined process and further indicating a response method according to the instruction condition; receiving the instruction message in the secondary device; executing the predetermined process ordered by the received instruction message in the secondary device; and generating a response message according to the response method indicated by the received instruction message to thereby transmit the generated response message from the secondary device to the primary device.

It will be obvious to those skilled in the art that various changes may be made in the above-described embodiments of the present invention. However, the scope of the present invention should be determined by the following claims.

What is claimed is:

1. A network system including a plurality of network devices communicably connected with each other, a primary device included in the network devices controlling a secondary device included in the network devices excluding the primary device,
the primary device comprising:
an execution instruction unit for transmitting an instruction message for ordering an execution of a predetermined process to the secondary device when a predetermined instruction condition is fulfilled; and
an information addition unit for adding, to the instruction message, method information indicating a response method according to the instruction condition,
the secondary device comprising:
a process execution unit for executing a predetermined process according to the instruction message when the instruction message is received from the primary device; and
an instruction response unit for generating a response message according to the response method indicated by the method information, and transmitting the generated response message to the primary device.

2. The network system of claim 1, wherein:
in the primary device, the information addition unit adds, to the instruction message, method information indicating a response method to respond that the instruction message is received; and
in the secondary device, when the response method is to respond that the instruction message is received, the instruction response unit generates a response message for responding that the instruction message is received, and transmits the generated response message to the primary device.

3. The network system of claim 1, wherein:
in the primary device, the information addition unit adds, to the instruction message, method information indicating a response method to respond that the process is executed according to the instruction message; and
in the secondary device, when the response method is to respond that the process is executed according to the instruction message, after the process execution unit executes the process, the instruction response unit generates a response message for responding that the process is executed, and transmits the generated response message to the primary device.

4. A network device comprising all the units included in the primary device in the network system of claim 1.

5. A network device comprising all the units included in the secondary device in the network system of claim 1.

6. A computer program product in a computer-readable medium, the product comprising instructions for achieving all the units included in the primary device of the network system of claim 1.

7. A computer program product in a computer-readable medium, the product comprising instructions for achieving all the units included in the secondary device of the network system of claim 1.

8. A method for indicating a response method in a network system communicably connecting a primary device and a secondary device controllable by the primary device, the method comprising the steps of:
transmitting an instruction message from the primary device to the secondary device when a predetermined instruction condition is fulfilled, the instruction message ordering an execution of a predetermined process and further indicating a response method according to the instruction condition;
receiving the instruction message in the secondary device;
executing the predetermined process ordered by the received instruction message in the secondary device; and
generating a response message according to the response method indicated by the received instruction message to thereby transmit the generated response message from the secondary device to the primary device.
